(19) United States
(12) Patent Application Publication
(10) Pub. No.: US 2026/0313355 A1
(43) Pub. Date: Oct. 8, 2026

(54) METHOD FOR DOWNLOADING MNO PROFILE, ELECTRONIC DEVICE AND COMPUTER READABLE STORAGE MEDIUM

(71) Applicant: Nanning FuLian FuGui Precision Industrial Co., Ltd., Nanning (CN)

(72) Inventors: Shu-Jun Wang, Shenzhen (CN); Xian-Qiao Liu, Shenzhen (CN)

(21) Appl. No.: 19/049,113

(22) Filed: Feb. 10, 2025

(30) Foreign Application Priority Data
Feb. 5, 2025 (CN) 202510130982.4

(51) Int. Cl. H04W 8/20; H04W 12/42

(52) U.S. Cl. CPC H04W 8/205; H04W 12/42

(57) ABSTRACT

A method for downloading a mobile network operator (MNO) profile is disclosed. When an embedded subscriber identity module (eSIM) card of an eSIM device is going to be activated, the eSIM device sends a download network request to a mobile application (APP) of a mobile phone via Bluetooth. The mobile APP sends the download network request to an MNO server to retrieve an MNO profile from the MNO server and transmits the MNO profile to the eSIM device via Bluetooth. After receiving the MNO profile, the eSIM device writes it into the eSIM card for activation.

The disclosure relates to data downloading, and more particularly to a method for downloading a mobile operator network (MNO) profile.

### BACKGROUND

An embedded subscriber identity module (eSIM) card is a programmable SIM card integrated into a device, replacing a traditional physical SIM card. The eSIM card can store and switch profiles of different mobile network operators (MNO), allowing users to switch MNOs more conveniently.

It should be noted that the eSIM card can change an MNO profile directly through the software. Users only need to download and save the MNO profile to the eSIM card, and the eSIM card can change MNOs and switch to a new network according to the MNO profile. However, before an electronic device activates the eSIM card, Internet access of the electronic device is not allowed, so that the electronic device itself cannot download the MNO profile independently.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of an embodiment of an architecture of a system for downloading an MNO profile of the present disclosure;

FIG. 2 is a flowchart of an embodiment of a method to download an MNO profile of the present disclosure;

FIG. 3 is a block diagram of an embodiment of a hardware architecture of an electronic device using the method of the present disclosure; and

FIG. 4 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

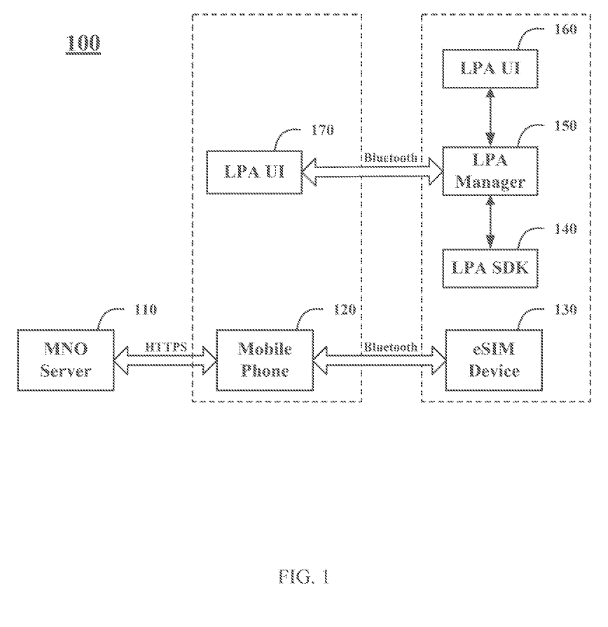

FIG. 1 is a schematic diagram of an embodiment of the architecture of a system for downloading MNO profile of the present disclosure.

The system 100 for downloading MNO profile comprises a mobile network (MNO) server 110, a mobile phone 120, an embedded subscriber identity module (eSIM) device 130, a local profile assistant (LPA) software development kit (SDK) 140, LPA manager 150 and LPA user interfaces 160 and 170. Each device and component are connected via Bluetooth and HyperText Transfer Protocol Secure (HTTPS).

It should be noted that the embodiment of the system 100 for downloading the MNO profile is a network architecture well known to those skilled in the art. The technical solution of the present invention is mainly based on this architecture and the SGP.22 download specification defined by Groupe Speciale Mobile Association (GSMA) to improve the original data transmission method, so the working principles of some components are not described in detail.

When an eSIM profile is going to be downloaded, the eSIM device 130 sends a download network request to the mobile phone 120 via Bluetooth. After receiving the download network request, the mobile phone 120 accesses the MNO server 110 to perform data exchange to obtain the eSIM profile, and simultaneously transmits the eSIM profile to the eSIM device 130 via Bluetooth. During the downloading process, multiple network interaction requests need to be completed. Bluetooth plays a bridge role in the network data transmission, accurately transmitting the network interaction data between the eSIM device 130 and the MNO server 110.

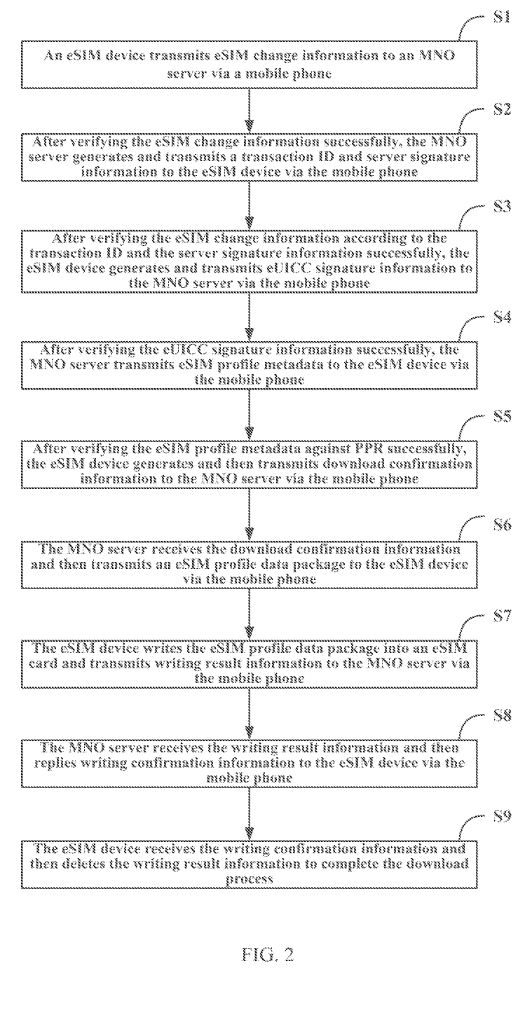

FIG. 2 is a flowchart of an embodiment of a method for downloading MNO profile of the present disclosure. According to different needs, the order of the steps in the flowchart can be changed, and some steps can be omitted. The method is applied to electronic devices including mobile wireless routers, smart watches and GPS positioning devices with eSIM cards, as well as any computer equipment that can establish a Bluetooth connection with a mobile phone and has an eSIM card.

In step S1, when an eSIM setting is going to be changed, the eSIM device 130 transmits eSIM change information to the mobile phone 120 via Bluetooth, and the mobile phone 120 transmits the eSIM change information to the MNO server 110.

In step S2, after verifying the eSIM change information, the MNO server 110 generates and transmits a transaction ID and server signature information to the mobile phone 120. The mobile phone 120 transmits the transaction ID and the server signature information to the eSIM device 130 via Bluetooth.

In step S3, after verifying the eSIM change information according to the transaction ID and the server signature information, the eSIM device 130 generates and transmits embedded Universal Integrated Circuit Card (eUICC) signature information to the mobile phone 120 via Bluetooth. The mobile phone 120 transmits the eUICC signature information to the MNO server 110.

In step S4, after verifying the eUICC signature information, the MNO server 110 transmits eSIM profile metadata to the mobile phone 120. The mobile phone 120 transmits the eSIM profile metadata to the eSIM device 130 via Bluetooth.

In step S5, after verifying the eSIM profile metadata against the Profile Policy Rules (PPR), the eSIM device 130 generates and then transmits download confirmation information to the mobile phone 120 via Bluetooth. The mobile phone 120 transmits the download confirmation information to the MNO server 110.

In step S6, the MNO server 110 receives the download confirmation information and then transmits an eSIM profile data package to the mobile phone 120. The mobile phone 120 transmits the eSIM profile data package to the eSIM device 130 via Bluetooth.

In step S7, the eSIM device 130 writes the eSIM profile data package into its eSIM card (not shown) and transmits writing result information to the mobile phone 120 via Bluetooth. The mobile phone 120 then transmits the writing result information to the MNO server 110.

In step S8, the MNO server 110 receives the writing result information and then replies writing confirmation information to the mobile phone 120. The mobile phone 120 then transmits the writing confirmation information to the eSIM device 130.

In step S9, the eSIM device 130 receives the writing confirmation information and then deletes the writing result information to complete the download process.

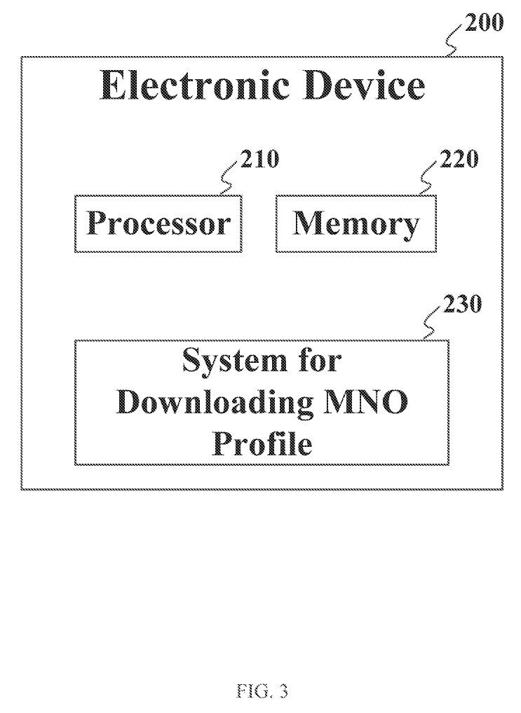

FIG. 3 is a block diagram of an embodiment of the hardware architecture of an electronic device using the method for downloading MNO profile of the present disclosure. The electronic device 200 may be, but is not limited to, connected to a processor 210, a memory 220, and a system 230 for downloading MNO profile via system buses. The electronic device 200 shown in FIG. 3 may include more or fewer components than those illustrated or may combine certain components.

The memory 220 stores a computer program, such as the system 230 for downloading MNO profile, which is executable by the processor 210. When the processor 210 executes the system 230 for downloading MNO profile, the blocks in one embodiment of the booting mode configuration method applied in the electronic device 200 are implemented, such as blocks S1 to S9 shown in FIG. 2.

It will be understood by those skilled in the art that FIG. 3 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the system 230 for downloading MNO profile and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The system 230 for downloading MNO profile can be partitioned into one or more modules/units that are stored in the memory 220 and executed by the processor 210. The one or more modules/units may be a series of computer program instructions capable of performing particular functions of the system 230 for downloading MNO profile.

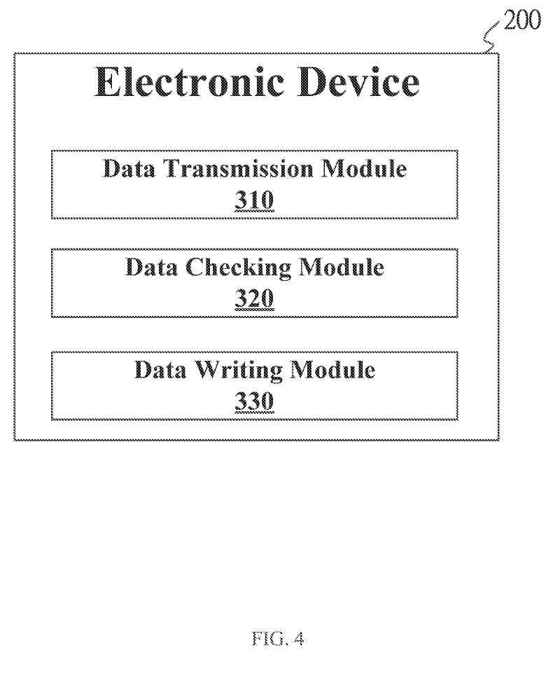

FIG. 4 is a schematic diagram of an embodiment of functional blocks of the electronic device using the method of the present disclosure.

The electronic device 200 comprises a data transmission module 310, a data verification module 320 and a data writing module 330.

When an eSIM setting is going to be changed, the data transmission module 310 transmits the eSIM change information to the mobile phone 120 via Bluetooth. The mobile phone 120 transmits the eSIM change information to the MNO server 110. After verifying the eSIM change information, the MNO server 110 generates and transmits a transaction ID and server signature information to the mobile phone 120. The data transmission module 310 retrieves the transaction ID and the server signature information from the mobile phone 120 via Bluetooth.

After verifying the eSIM change information according to the transaction ID and the server signature information, the data verification module 320 generates and transmits eUICC signature information to the mobile phone 120 via Bluetooth. The mobile phone 120 transmits the eUICC signature information to the MNO server 110. After verifying the eUICC signature information, the MNO server 110 transmits eSIM profile metadata to the mobile phone 120.

The data verification module 320 retrieves the eSIM profile metadata from the mobile phone 120 via Bluetooth, and, after verifying the eSIM profile metadata against the PPR, generates download confirmation information and then transmits the download confirmation information to the mobile phone 120 via Bluetooth. The mobile phone 120 transmits the download confirmation information to the MNO server 110. The MNO server 110 receives the download confirmation information and then transmits an eSIM profile data package to the mobile phone 120.

The data writing module 330 retrieves the eSIM profile data package from the mobile phone 120 via Bluetooth, writes the eSIM profile data package into its eSIM card (not shown) and transmits writing result information to the mobile phone 120 via Bluetooth. The mobile phone 120 then transmits the writing result information to the MNO server 110. The MNO server 110 receives the writing result information and then replies writing confirmation information to the mobile phone 120.

The data writing module 330 receives the writing confirmation information from the mobile phone 120 via Bluetooth and then deletes the writing result information to complete the download process.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method to download an MNO profile executable by an electronic device, the method comprising:
when an embedded subscriber identity module (eSIM) setting is changed, transmitting eSIM change information to a mobile phone via Bluetooth, wherein the mobile phone transmits the eSIM change information to an MNO server and the MNO server, after verifying the eSIM change information, generates and transmits a transaction ID and server signature information to the mobile phone;
retrieving the transaction ID and the server signature information from the mobile phone via Bluetooth, and, after verifying the eSIM change information according to the transaction ID and the server signature information, generating and transmitting embedded Universal Integrated Circuit Card (eUICC) signature information to the mobile phone via Bluetooth, wherein the mobile phone transmits the eUICC signature information to the MNO server and the MNO server, after verifying the eUICC signature information, transmits eSIM profile metadata to the mobile phone;
retrieving the eSIM profile metadata from the mobile phone via Bluetooth and, after verifying the eSIM profile metadata against the Profile Policy Rules (PPR), generating and transmitting download confirmation information to the mobile phone via Bluetooth, wherein the mobile phone transmits the download confirmation information to the MNO server and the MNO server receives the download confirmation information and then transmits an eSIM profile data package to the mobile phone; and
retrieving the eSIM profile data package from the mobile phone, writing the eSIM profile data package into an eSIM card and transmitting writing result information to the mobile phone via Bluetooth, wherein the mobile phone transmits the writing result information to the MNO server.

2. The method of claim 1, further comprising:
retrieving writing confirmation information from the mobile phone, wherein the MNO server receives the writing result information from the mobile phone and then replies the writing confirmation information to the mobile phone; and
receiving the writing confirmation information and then deletes the writing result information to complete the download process.

3. An electronic device, which includes a memory, a processor, and a serial number length adjustment program stored in the memory and operable on the processor, wherein the downloading MNO profile program is executed by the processor to implement following steps:
when an eSIM setting is changed, transmitting eSIM change information to a mobile phone via Bluetooth, wherein the mobile phone transmits the eSIM change information to an MNO server and the MNO server, after verifying the eSIM change information, generates and transmits a transaction ID and server signature information to the mobile phone;
retrieving the transaction ID and the server signature information from the mobile phone via Bluetooth, and, after verifying the eSIM change information according to the transaction ID and the server signature information, generating and transmitting eUICC signature information to the mobile phone via Bluetooth, wherein the mobile phone transmits the eUICC signature information to the MNO server and the MNO server, after verifying the eUICC signature information, transmits eSIM profile metadata to the mobile phone;
retrieving the eSIM profile metadata from the mobile phone via Bluetooth and, after verifying the eSIM profile metadata against the PPR, generating and transmitting download confirmation information to the mobile phone via Bluetooth, wherein the mobile phone transmits the download confirmation information to the MNO server and the MNO server receives the download confirmation information and then transmits an eSIM profile data package to the mobile phone; and
retrieving the eSIM profile data package from the mobile phone, writing the eSIM profile data package into an eSIM card and transmitting writing result information to the mobile phone via Bluetooth, wherein the mobile phone transmits the writing result information to the MNO server.

4. The device of claim 3, wherein the downloading MNO profile program is further executed by the processor to implement following steps:
retrieving writing confirmation information from the mobile phone, wherein the MNO server receives the writing result information from the mobile phone and then replies the writing confirmation information to the mobile phone; and
receiving the writing confirmation information and then deletes the writing result information to complete the download process.

5. A non-transitory computer-readable storage medium storing game program which causes a computer to execute:
a process of, when an eSIM setting is changed, transmitting eSIM change information to a mobile phone via Bluetooth, wherein the mobile phone transmits the eSIM change information to an MNO server and the MNO server, after verifying the eSIM change information, generates and transmits a transaction ID and server signature information to the mobile phone;
a process of retrieving the transaction ID and the server signature information from the mobile phone via Bluetooth, and, after verifying the eSIM change information according to the transaction ID and the server signature information, generating and transmitting eUICC signature information to the mobile phone via Bluetooth, wherein the mobile phone transmits the eUICC signature information to the MNO server and the MNO server, after verifying the eUICC signature information, transmits eSIM profile metadata to the mobile phone;
a process of retrieving the eSIM profile metadata from the mobile phone via Bluetooth and, after verifying the eSIM profile metadata against the PPR, generating and transmitting download confirmation information to the mobile phone via Bluetooth, wherein the mobile phone transmits the download confirmation information to the MNO server and the MNO server receives the download confirmation information and then transmits an eSIM profile data package to the mobile phone; and
a process of retrieving the eSIM profile data package from the mobile phone, writing the eSIM profile data package into an eSIM card and transmitting writing result information to the mobile phone via Bluetooth, wherein the mobile phone transmits the writing result information to the MNO server.

6. The non-transitory computer-readable storage medium according to claim 5, further comprising:
a process of retrieving writing confirmation information from the mobile phone, wherein the MNO server receives the writing result information from the mobile phone and then replies the writing confirmation information to the mobile phone; and
a process of receiving the writing confirmation information and then deletes the writing result information to complete the download process.
